(19) United States
(12) Patent Application Publication
(10) Pub. No.: US 2008/0160336 A1
(43) Pub. Date: Jul. 3, 2008

(54) Process for Producing Porous Metal, Porous Metal and Porous Metallic Structure

(75) Inventor: Yoshihiro Tada, Tokushima (JP)

Correspondence Address: BEYER WEAVER LLP, P.O. BOX 70250, OAKLAND, CA, 94612-0250, US

(73) Assignee: The University Of Tokushima

(21) Appl. No.: 11/884,175

(22) PCT Filed: Feb. 10, 2006
(86) PCT No.: PCT/JP06/02344

§ 371 Date: Aug. 9, 2007

(30) Foreign Application Priority Data
Feb. 18, 2005 (JP) 2005-043120

(51) Int. Cl. B22F 3/20; B32B 5/18

(52) U.S. Cl. 428/613; 419/2

(57) ABSTRACT

A porous metal is produced by sequentially carrying out the steps of obtaining a mixture by mixing metal powder and hole forming medium powder, obtaining a molding by stretching this mixture, and removing the hole forming medium powder from the molding by dissolving in water.

This application is a continuation of International Application No. PCT/JP2006/302344, filed Feb. 10, 2006 which claims priority on Japanese Patent Application 2005-043120 filed Feb. 18, 2005.

### BACKGROUND OF THE INVENTION

This invention relates to a method of producing porous metal, porous metals and porous metallic structures. The porous metallic structures of this invention are utilizable in any technical field that can make use of their porous characteristics.

Japanese Patent Publication Tokkai 2002-129204 discloses a method of producing a porous metallic structure. According to this prior art technology as shown in FIG. 21, metallic powder and salt in a powder form are mixed (101), this mixture is heated to a temperature which is lower than the melting point of the salt but higher than that of the metallic powder so as to melt the metallic powder (102), a pressure is applied to this mixture such that the melted metal will fill the space between the salt powder to obtain a molding (103), and the salt is washed off with water from this molding (104) to obtain a porous metallic structure.

This prior art technology is based on the traditional casting method by causing a melting hot water to permeate a kind of mold made of table salt particles to obtain a porous body and is characterized as preliminarily mixing metallic powder with table salt such that the step of pouring hot water can be eliminated and the preventive characteristic of generation of nests and large pores due to insufficient water circulation can be improved. This prior art technology, however, has the following problems.

(1) By this prior art technology, the formed pore structure is a three-dimensional network and basically isotropic. Thus, it is not possible to form air bubbles that are continuous in one direction.

(2) By this prior art technology, it is essential that the salt particles be continuous. If they are not continuous, the metallic particles may be segregated due to the buoyant force when they float and it becomes useless for obtaining a porous metallic structure with the ratio of air holes at 50 volume % or less.

(3) Since the dimension of a porous metallic structure obtained by this prior art technology is determined by the size of the mold, it is difficult from a practical point of view to obtain a long or wide object.

(4) The cost of equipment becomes high according to this prior art technology because a special mold provided with an air-transmitting layer and vacuum air discharge equipment is required.

(5) The production cost becomes high according to this prior art technology because the mold is heated as a whole and the energy consumption is high.

For all of these reasons, the practical application of this prior art technology is severely restricted.

### SUMMARY OF THE INVENTION

It is therefore an object of this invention in view of the above to provide a process for producing porous metallic structures inexpensively by a simple production equipment and with a reduced energy consumption. Another object of this invention is to provide porous metals and in particular porous metals having many pores continuously extending in one direction, as well as structures using such metals.

A process of this invention for producing a porous metal may be characterized as comprising sequentially carrying out the steps of obtaining a mixture by mixing metal powder and hole forming medium powder, obtaining a molding by stretching this mixture, and dissolving and thereby removing the hole forming medium powder from the molding. In the above, the molding may be obtained by an extrusion process or by a rolling process. The stretching process by which the molding is obtained may be carried out by heating to a temperature lower than the melting points of the metal powder and the hole forming medium powder. The step of obtaining a compressed powder member by compressing the mixture may be carried out prior to the step of stretching the mixture.

The invention also relates to a porous metal characterized as comprising a metallic member formed by stretching in one direction and having continuous air holes within a sectional area or more specifically as being an extruded product obtained by a process of this invention, having continuous air holes that are mutually independent within its sectional surface and extends in the direction of extrusion or being a rolled product obtained by a process of this invention, having continuous air holes formed inside and extending in the direction of rolling, as well as to a porous metallic structure comprising a porous metal formed by stretching in one direction and having continuous air holes formed in the direction of stretching in its sectional area and a non-porous metallic member laminated to the porous metal.

Merits of this invention are described in the specification that follows.

### BRIEF DESCRIPTION OF THE DRAWINGS

FIG. 1 is a process diagram of a production method embodying this invention.

FIG. 2A shows the principle of generation of fresh new surfaces at the time of an extrusion process, and FIG. 2B is a drawing that shows table salt particles serving as powder for forming air holes inside a metal.

FIG. 3 is a graph that shows the relationship between the mixing ratio of table salt and porosity with respect to the salt removal time.

FIG. 4 is a graph that shows the relationship between the ratio of added table salt and the porosity after the salt removal process

FIG. 5 is a graph that shows the change in the salt removal ratio with respect to the added quantity of table salt.

FIGS. 6A and 6B are stereo micrographs showing the fiber structures of extruded aluminum.

FIGS. 7A, 7B, 7C and 7D are stereo micrographs comparing the stretched conditions of aluminum according to the extrusion ratio.

FIGS. 8A 8B, 8C, 8D and 8E are stereo micrographs showing changes in air holes on a sectional surface perpendicular to the direction of extrusion according to the mixing ratio of table salt.

FIGS. 9A, 9B, 9C and 9D are stereo micrographs showing the changes in the shapes and structures of air holes in an extruded material according to the kind of table salt.

FIG. 10 is a graph that shows the changes in the average diameter of air holes (or their equivalent circles) according to the kinds and mixing ratios of table salt.

FIGS. 11A, 11B, 11C, 11D and 11E are stereo micrographs showing the changes in the shapes and structures of air holes according to the extrusion temperature.

FIG. 12 is a graph that shows the changes in the average diameter of air holes according to the extrusion temperature.

FIGS. 13A, 13B, 13C, 13D, 13E and 13F are stereo micrographs of radial air hole structures obtained by high extrusion ratios.

FIGS. 14A and 14B are stereo micrographs showing the changes in the air hole structures according to the diameters of aluminum particles.

FIG. 15 is a graph that shows the results of measurement of ventilation resistance of the porous metal.

FIG. 16 is a graph that shows the results of measurement of hardness of porous metals.

FIG. 17 is a photograph of four porous metallic structures embodying this invention.

FIG. 18 is a photograph of a composite pipe of the sandwich type as an example of porous metallic structure of this invention.

FIG. 19 is a photograph of another composite pipe of the outer cover type.

FIG. 20 is a photograph of a diagonal sectional view of the composite pipe of FIG. 18.

FIG. 21 is a process diagram of a prior art production method of a porous metal.

### DETAILED DESCRIPTION OF THE INVENTION

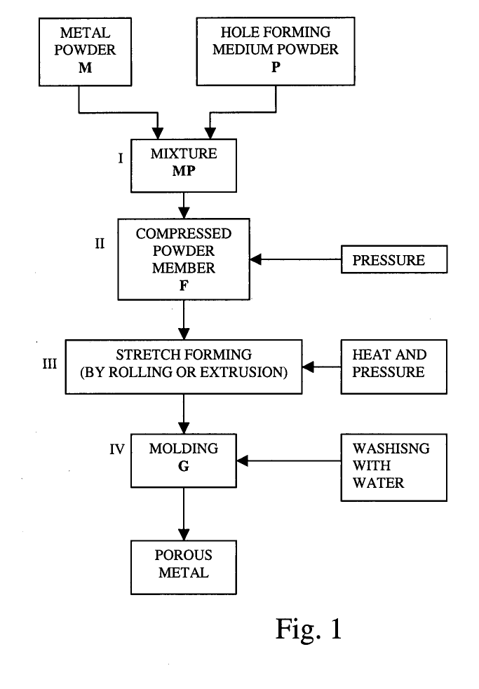

The invention is described next with reference to the drawings. FIG. 1 is a process diagram showing a production method embodying this invention. FIG. 2A is a diagram for showing the principle of generation of fresh new surfaces at the time of an extrusion process. FIG. 2B shows particles for forming air holes inside a metal.

As shown in FIG. 1, a porous metal of this invention is produced by sequentially carrying out a mixing step I in which metal powder M and a hole forming medium (salt powder) P are mixed to obtain a mixture MP, a stretch forming step III in which the mixture MP is stretched by the extrusion method to obtain a molding G, and a salt removal step IV in which the hole forming medium is dissolved and removed from this molding G. In the above, the stretch forming means a forming method in which pressure is applied to the mixture MP so as to plastically deform it in one direction and includes compression molding (or rolling) and extrusion molding.

According to this invention, it is preferable to carry out the stretch forming step by a method of extrusion molding or compression molding such as roll compression. By a stretch forming step by extrusion molding and roll compression, the production of a porous metal having longitudinally continuous air holes inside an elongated metallic material becomes easier. By a method of continuous extrusion molding and powder compression, it is possible to obtain elongated porous metals of any desired length, having longitudinally continuous air holes since there is practically no limit to the molding length.

The stretch forming step III of this invention, in which extrusion molding or compression molding is carried out, may preferably be carried out under a heated condition to a temperature lower than the melting point of the metallic powder and the hole forming medium.

A compression step II may be carried out between the mixing step I and the stretch forming step III to compress the aforementioned mixture so as to obtain a compressed powder member F.

According to this invention, metal powder M and a hole forming medium P are mixed and preferably heated or compressed such that the metal powder and the hole forming medium are simultaneously stretched. As they are stretched, the metal powder becomes bonded together and unified and since the hole forming medium also exists within the stretched metallic body while it itself is in a stretched condition, it is possible to obtain a porous metallic body having many air holes stretched in the direction of extrusion or compression (or rolling) as the stretched hole forming medium is washed away.

Next, porous metallic bodies and porous metallic compositions of this invention, as well as methods of their production will be explained in detail.

### Metallic Materials

### (1) Kinds

Metals that are usable in this invention as those having the following properties.

As the metal particles undergo plastic deformations in the compression molding process and their surface areas increase, fresh new surfaces should be generated such as they can metallically bond together. Thus, the metallic material should be stretchable. Fragile materials are not preferred.

The compression molding process for combining the metallic particles together must be possible within a temperature range lower than the melting point of the hole forming medium.

The hole forming medium must also be able to stretch at this fabrication temperature.

Any metallic powder satisfying these conditions can be used for the purpose of the present invention. Representative examples of such metal include aluminum, magnesium, zinc, tin, copper and their alloys

### (2) Particle Size

The metallic material is used in a powder form so as to be able to uniformly mix with the powder of the hole forming medium which serves as the source of air holes. The particle size of the metallic powder can be obtained mainly from the ease with which it can mix with the hole forming medium and the metallic particles can bond together at the time of the stretch forming. As long as extrusion molding or compression molding is possible, there is no restriction as to its upper limit or to its lower limit. Since the air hole composition changes, depending on the difference in particle size with the hole forming medium, however, the preferable particle size is determined relative to the particle size of the hole forming medium. In the above, the particle size means the size of the opening of the filter.

### Hole Forming Medium

### (a) Kinds

The hole forming medium is used as a medium which extends in the direction of extrusion or compression during the stretch forming step while remaining dispersed within the metallic material and serving to form air holes after being dissolved away. Thus, use may be made of any medium capable of remaining inside a metallic material in a powder form or an elongated form and of being dissolved away with water. Representative examples of such hole forming medium include sodium chloride (or so-called table salt) NaCl and potassium chloride KCl.

### (b) Particle Size

The particle size of the hole forming medium may preferably be obtained from the following conditions.

Firstly, a preferable range may be obtained from the point of view of the diameter of the hole after the molding but since this depends on the degree of stretching, it cannot be determined in terms of an absolute value. An optimum value may be determined according to various conditions.

Secondly, an optimum range of the size of the hole forming medium may be determined from the relationship with the particle size of the metallic powder. If the particle size of the hole forming medium is small compared to the metallic particles, the bonding between the metallic particles is adversely affected. Thus, a lower limit of the particle size of the hole forming medium may be determined from the ease with which the metallic particles can bond together. On the other hand, if the metallic particles are small and the particles of the hole forming medium are large, air holes may be cleanly separated but if the particles of the hole forming medium are too large, it becomes difficult to form very small air holes. Thus, the size of the metallic particles should be taken into consideration from the number and size of the air holes that are desired.

When ordinary salt (NaCl or KCl) is used as the hole forming medium, however, the particle size is generally preferred to be in the range of 1-10000 μm and more preferably in the range of 10-3000 μm from the point of view, for example, of the ease of handling. Here, again, the particle size means the filter opening.

### Mixing Step I

According to this invention, powder of hole forming medium P is mixed into metallic powder M in the first step. The mixing ratio of the hole forming medium P is increased if it is desired to increase the number and/or volume or surface ratio of the air holes, and it is reduced if it is desired to decrease the number and/or volume or surface ratio of the air holes. In short, since the number of the air holes is proportional to the ratio of the hole forming medium, it can be determined according to the desired number of the air holes. Although the lower limit of the quantity to be added is determined by the required characteristic based on the purpose of use, the volume % of the hole forming medium is generally within the range of 20-70%, which is considered an optimum range.

Although the upper limit of the ratio is not uniquely dependent upon the kind of the metal, the effects of the kind of metal is believed to relatively increase from the point of view of the ease of bonding between the metallic particles if the metallic particles and the hole forming medium are very small. The kind of the metal does not affect the lower limit.

### Compression Step II

In order to make the handling of the mixture MP easier at the time of preheating in case the compression molding in the step is to be carried out while heating, a mold is used to make it solid in a columnar form or in some other form. If it is thus made compact once, the separation of the mixture MP due to its density difference can be prevented such that the handling becomes easier.

This process, however, may be omitted and the mixture MP may be directly subjected to the extrusion or compression molding process without causing any trouble. In this sense, this step is not essential in this invention.

### Stretch Forming Step III

### (1) Significance of Stretch Forming

This is the most important step of this invention in which the mixture MP of the powder of metal and hole forming medium or its compressed body F is stretched by extrusion or compression either in heated or cold condition. Either by extrusion or by compression, the oxide films covering the metallic particles are broken and the metallic particles come to be bonded to become a unified metallic member. Since the hole forming medium dispersed within the metallic member becomes stretched inside this metallic member at this moment, air holes come to be formed if this hole forming medium is washed with water and dissolved away.

This extrusion or compression process has the technical significance as an operation for unitarily bonding metallic particles. As long as this goal can be accomplished, this process may be carried out in whatever manner. It now goes without saying that these air holes are formed in an elongated manner in the direction of the extrusion or compression.

The extrusion molding process is preferable for forming air holes extending in one direction. In what follows, the extrusion molding process is described more in detail.

### (2) Extrusion Molding Process

If the mixture MP of the compressed member F of metal and hole forming medium is extruded by a conventional extrusion technology whether in the heated or cold condition, the powder particles of the metal and the hole forming medium become stretched as shown in FIG. 2A in the form of fibers. In this situation, as the metallic particles M are stretched, the oxide film covering the particles is broken and the particles become bonded together to form a unified metallic member. In the meantime, as shown in FIG. 2B, the powder particles P of the hole forming medium become elongated like fibers inside the metal particles forming the metallic member. These elongated powder particles P serve as media for forming air holes. If table salt (NaCl or KCl) is used as the hole forming medium, it cannot be accurately determined whether the salt being extruded is undergoing plastic deformation into a stretched form or is merely being rearranged into fiber forms inside the flow lines of the metal particles while being fragilely broken up.

Any of the know methods of prior art extrusion molding may be used for the purpose of this invention. The shape and the diameter of the opening of the container and the die to be used may be set in any manner according to the specifications of the porous metallic member intended to be obtained. Methods like continuous extrusion and hydrostatic extrusion may be freely adopted.

### (3) Behavior of the Metal During Stretching

### ((Fresh New Metallic Surfaces))

The powder surfaces of the metal such as aluminum are covered with an oxide film. In general, the oxide bonding is ionic bonding, covalent bonding or their mixture, and not metallic bonding. Thus, metallic particles do not come to be bonded together even if they are pressed together with a high pressure with an oxide film in between. In order to cause metallic bonding between powder particles, therefore, it is necessary to break up this oxide film to expose new metallic surfaces that are not contaminated (herein referred to as the fresh new surfaces) and to press these fresh new surfaces together with a high pressure such that they come to within the distance of their mutual atomic forces. For generating fresh new surfaces, operations of breaking up the oxide film and increasing surface areas are necessary, such as crashing or stretching the powder particles. It is more effective if shearing deformation is added.

### ((Hot and Cold Processes))

Temperature is not an important factor. If fresh new surfaces can be generated sufficiently and the surfaces can be pressed together sufficiently, bonding can be accomplished even at room temperatures (cold bonding). Thus, the present invention is intended to include cold extrusion processes. Since metallic bonding between contacting surfaces becomes easier as the temperature is raised, however, it is more effective to including a heating process. It is particularly effective to heat to a temperature above the recrystallization temperature of the metallic material. The plastic process above the recrystallization temperature is called a hot process.

### ((Extrusion Process))

The extrusion process is a preferable process for solidifying metallic particles because not only a high pressure is applied and the surface areas of the powder particles are increased but also a shear deformation is operated. It may be considered as the most appropriate process for solidifying metallic particles because the hot extrusion adds the factor of high temperature that accelerates metallic bonding. Oxide films on aluminum powder particles (aluminum oxide) are particularly strong, and aluminum powder is considered to be one of the hardest to solidify among ordinary metals. Hot extrusion is considered preferable in the present invention not only from the point of view of stretching of hole forming medium but also from the point of view of the bonding of metallic powder.

### (4) Extrusion Ratio

One of the parameters related to extrusion process is the extrusion ratio. If a material with sectional area A₀ inside a sealed container is pushed from one end to be extruded from a die having an opening with sectional area A₁, the extrusion ratio R is defined as R=A₀/A₁.

During the extrusion process, metallic powder particles bond together and become unified as fresh new surfaces are generated. The generation ratio of the fresh new surfaces in this situation (or the ratio at which the metal particles are extended, the oxide films on their surfaces are broken up and fresh new surfaces are generated) depends not only on the angle of the die and the shape of the opening but also mainly on the extrusion ratio. If the generation ratio of fresh new surface is 70% or more, it is generally possible to produce a porous metal, although it is only a rule of thumb because there are kinds of metal for which the production is possible with a smaller or larger generation ratio. The extrusion ratio of the die to be used for the process may be freely selected as long as this condition is satisfied. In the test examples to be described below, the extrusion ratio is 6.7 and 17.6 but they are not intended to be optimum examples.

The upper limit of the extrusion ratio is determined by the pressure resistance of the extruder, the pressure of extrusion (meaning the required pressure per unit area determined by the deformation resistance of the material being worked upon and the extrusion ratio) and the power quantity of the press and is not an essential quantity of this invention. The lower limit is about 3 in the case of hot extrusion although it depends on the kind and characteristics of the metallic powder, extrusion temperature and the composition of the hole forming medium for accomplishing the bonding of the metallic powder particles.

### (5) Extrusion Temperature

The extrusion process of this step can be carried out either under a heated or cold condition. The extrusion temperature when it is carried out under a heated condition should be such that both the hole forming medium and metal particles are stretched and the metallic particles can bond together. If table salt is used as the hole forming medium, for example, since the melting point of table salt as NaCl is 800° C. and that of aluminum Al is 660° C., the extrusion temperature may be in the range of 300-500° C. and preferably around 450° C. but it is only an example and the invention does not make it a requirement.

If the extrusion temperature is increased, extrusion becomes easier since both the metal and the hole forming medium become softer to make the production process easier.

### (6) Strengths of Metal and Hole Forming Medium Powder Particles

When the mixture MP or the compressed powder member F is extruded, the deformation becomes more uniform and the extension becomes easier if the strengths (deformation resistances) of the powder particles of the metal and hole forming medium are similar. If the difference in strength is large, on the other hand, only the softer powder particles are extended. If the strength ratio is within 1:1-1:3, both powder particles can be stretched approximately uniformly without regard to the distribution ratio between the metal and hole forming medium powder particles. It is more preferable that the strength ratio be closer to 1:1 because the metal and hole forming medium powder particles are stretched together.

### Salt Removal Process IV

As the last step of the present invention, the molding G obtained by the extrusion is washed with water. In other words, it is immersed in water such that the hole forming medium in the stretched form is dissolved and removed.

If the hole forming medium comprises salt, the salt removal characteristics are hardly affected whether still water or flowing water is used for the washing process. Since salt is being dissolved, however, it should be clearly understood that a sufficient amount of still water should be used such that it will not become saturated even after the total amount of the salt has been dissolved. The speed of salt removal does not change much whether still water or flowing water is used. It may be because still water works on the salt inside small holes except in the surface layer portions.

Since elongated hollow holes result after the salt is removed, these elongated holes become the air holes. Many such elongated air holes will result within a cross-sectional area and some of them connect each other sequentially in the longitudinal direction.

Characteristics of Porous Metal thus Obtained

Porous metals produced by the present invention have many air holes extending in the direction of extrusion or compression, and some of these air holes are sequentially connected, having continuous and ventilating characteristics. Porous metals of this invention are characterized not only as having air holes uniformly distributed within any cross-sectional surface but also as having air holes distributes with their density varying stepwise or in an sloped manner. If table salt is used as the hole forming medium and if its concentration is less than about 30 volume %, the probability of its particles mutually encountering drops and they may stop connecting after only a few of them become connected. If the concentration is higher, a plurality of salt particles will join together to form an elongated air hole, and the probability of an air hole coming to a stop is extremely small. In other words, there are many air holes connected continuously in the direction of the extrusion.

Let us now assume that a cubic salt particle with side a is deformed isotropically by an extrusion process (with extrusion ratio=R). On the assumption that the volume of the salt particle does not change, this salt particle will result in a hole with a square cross-sectional shape with side a/\sqrt{R} (=air hole diameter) and length aR. Thus, if the average diameter of salt particles is 417.5 μm, the air hole diameter is about 160 μm and the length of air hole formed by one salt particle is about 2.9 mm if R=6.9, and they are respectively about 100 μm and about 7.4 mm if R=17.6. If the average diameter of salt particles is 467.0 μm, the air hole diameter is about 180 μm and the length of air hole formed by one salt particle is about 3.2 mm if R=6.9, and they are respectively about 110 μm and about 8.2 mm if R=17.6.

Thus, each air hole is fairly long, and if several such air holes are connected together, they become a continuous air hole in most situations.

### Merits of the Production Method

The production method according to this invention has the following technical merits, in addition to the merit that a metal having many continuous air holes can be obtained.

(1) Air holes elongated in the direction of extrusion or compression can be formed. When the extrusion or compression molding method is used, in particular, there is hardly any limitation regarding the production of elongated products. If the continuous extrusion method or the powder rolling technology is used, there is hardly any upper limit not only to the porous metal that is obtained but also to the length of the continuous air holes inside.
(2) No special apparatus or equipments are necessary for the producing of porous metals. Since a general-purpose equipment for extrusion or rolling can be directly used, the investment cost does not become high.
(3) The method is usable under any condition of heating in view of the pressure-resistance of the tools for the extrusion or rolling, bonding of the metal powder particles and the stretching of the hole forming medium. Since the metal powder particles need not be melted, the energy consumption is lowered and the production cost is reduced.
(4) The diameter and shape of the air holes can be controlled by the characteristics and ratios of the metal and hole forming medium and the condition of the extrusion or rolling such that different kinds of porous metals can be produced accurately.
(5) The air hole ratio, which is the number of continuous air holes within a cross-sectional area, can be controlled by adjusting the ratio of the hole forming medium, etc. and hence can be varied to be either small or large.
(6) An example has been explained above for the production of a porous member having air holes dispersed uniformly inside. Based on its basic principles, it is possible to produce porous members having the following kinds of higher-order structure with improved controllability.

(i) Porous metals of which the porosity varies stepwise or in a slope either in the longitudinal or radial direction produced by varying the ratio of the hole forming medium in the direction of the height or in the radial direction at the stage of preparing the compressed powder member.

(ii) Porous metals in which the diameters of the air holes vary either in the longitudinal or radial direction produced by varying the particle diameters of the metal and hole forming medium powder particles in the direction of the height or in the radial direction at the stage of preparing the compressed powder member.

(iii) Porous metals in which the distributions of the porosity and the diameters of the air holes over a cross-sectional are intentionally varied by combining the production methods of (i) and (ii).

### Porous Metallic Structures

Porous metallic structures of this invention may be obtained in the form of a bar, a hollow tube or a plate. In the former cases, the cross-sectional shape need not be circular but may be polygonal or elliptical. In the case of a planar shape, its thickness and width may be freely selected. Moreover, a porous metal of this invention and an ordinary non-porous metal may be combined together to produce a composite member. Such structures may be subjected, according to the needs, to a removal work such as cutting and polishing, or a plastic working method may be used for a secondary forming.

FIG. 17 shows examples of porous metallic structures produced by using metallic powder particles of aluminum. Example (A) shows a circular bar with porosity=25 volume %. Example (B) shows a composite tube with an outer non-porous pure aluminum pipe and an inner porous pipe with porosity=75 volume %. Example (C) shows another circular bar with porosity=50 volume %. Example (D) shows still another circular bar with porosity=75 volume %. Since structures with different porosity can be obtained, they can be used selectively according to the required factors such as strength and degree of ventilation.

FIGS. 18-20 show composite pipes using the aluminum pipe of Example (B) of FIG. 17.

The example shown in FIG. 18 is of the so-called sandwich type. FIG. 18 shows a photographed sectional view of an extruded material with diameter of 16 mm with no salt removal or polishing step carried out thereon. Described structurally, it comprises two aluminum pipes as non-porous metallic members on the outside and inside of a porous metallic member sandwiched in between. The porous member comprises aluminum powder with 75 volume % of table salt. The opening at the center is filled with salt and an extrusion process was carried out such that it would not be crushed. Non-porous aluminum pipes and aluminum powder can be simultaneously extruded as shown in FIG. 18 by using a composite billet having a mixture of aluminum and table salt particles or its compressed member inserted between inner and outer aluminum pipes (as porous or compressed powder members) having the same structures as the target composite pipe to be produced but larger and salt power particles or their compressed member in the opening of the inner pipe. Since the porous and non-porous metallic parts become united by metallic bonding during the extrusion process, there is no attachment or welding process needed for the unification. After a salt removal process, a pipe of a sandwiched structure having non-porous aluminum pipes on the inner and outer circumferences is obtained. Positioning of the porous and non-porous parts and the porosity of the porous metallic part may be varied appropriately according to the purpose. If a solid bar is used instead of the inner pipe, for example, a solid bar-shaped member having a porous metallic part of aluminum sandwiched between inner and outer non-porous aluminum pipes can be obtained. If a mixture of aluminum and salt particles or its compressed member is used instead of the salt of FIG. 18, a combination of four layers is obtained.

FIG. 19 shows another example of composite pipe of the so-called outer cover type using aluminum pipes. The production method is the same as for the example explained above with reference to FIG. 18 except that the non-porous aluminum pipe is not used inside, only the outside being covered with a non-porous aluminum pipe. An inner cover type with the positions of the non-porous aluminum pipe and the porous metallic part reversed can also be produced in an entirely same manner.

FIG. 20 is a photograph of a sectional view of the composite pipe of FIG. 18 along a diagonal plane, showing the structure after polishing and salt removal processes. As can been ascertained therein, the porous aluminum portion with 75 volume % is completely connected and unified with the aluminum pipes on the inner and outer circumferences.

Although examples of hollow composite pipes were shown above, pipes with a solid interior may be produced and the sectional shape need not be circular and may be freely varied. By a rolling process, composite materials with planar porous and non-porous metallic members piled one on top of the other can also be produced. Moreover, the plastic working process may be adopted as a secondary work process to obtain various shapes including curved surfaces. With a polishing process, various shapes can further be obtained.

### EXAMPLES (By Using Table Salt)

A porous metal was produced under the following conditions by using aluminum as the metallic material and salt (NaCl or KCl) as the hole forming medium.

The distribution of size and composition of the aluminum powder samples were as shown in Table 1 (for Sample 1) and Table 2 for (Sample 2).

TABLE 1

| | Mass percentage (%) |
|---|---|
| Particle diameters | |
| Less than 106 μm | 5.1 |
| 106 μm-150 μm | 31.8 |
| 150 μm-250 μm | 37.6 |
| 250 μm-425 μm | 25.4 |
| Over 425 μm | 0.1 |
| Element | |
| Fe | 0.10 |
| Cu | Trace |
| Si | 0.05 |
| Mn | Trace |
| Ti | Trace |
| Zn | Trace |
| Al | Balance |

TABLE 2

| | Mass percentage (%) |
|---|---|
| Particle diameters | |
| Less than 45 μm | 87.6 |
| 45 μm-63 μm | 8.3 |
| Over 63 μm | 3.1 |
| Element | |
| Fe | 0.14 |
| Cu | Trace |
| Si | 0.05 |
| Mn | Trace |
| Ti | Trace |
| Zn | Trace |
| Al | Balance |

The distribution of size and composition of the salt samples were as shown in Table 3 (for Sample C ) and Table 4 for (Sample S).

TABLE 3

| | Mass percentage (%) |
|---|---|
| Particle diameters | |
| Less than 150 μm | 0.2 |
| 150 μm-250 μm | 1.1 |
| 250 μm-300 μm | 5.8 |
| 300 μm-355 μm | 17.8 |
| 355 μm-425 μm | 30.7 |
| 425 μm-500 μm | 26.8 |
| 500 μm-600 μm | 15.1 |
| Over 600 μm | 2.5 |
| Average diameter | 417.5 μm |
| Component | |
| NaCl | 99.551 |
| Water | 0.081 |
| K | 0.124 |
| Mg | 0.018 |
| Ca | 0.020 |
| SO₄ | 0.017 |

TABLE 4

| | Mass percentage (%) |
|---|---|
| Particle diameters | |
| Less than 150 μm | 0.5 |
| 150 μm-250 μm | 1.6 |
| 250 μm-355 μm | 8.9 |
| 355 μm-425 μm | 11.9 |
| 425 μm-500 μm | 34.0 |
| 500 μm-600 μm | 40.5 |
| 600 μm-710 μm | 2.3 |
| Over 600 μm | 0.3 |
| Average diameter | 467.0 μm |
| Component | |
| NaCl | 99.833 |
| Water | 0.010 |
| K | 0.034 |
| Mg | 0.007 |
| Ca | 0.006 |
| SO₄ | 0.002 |

Use was made of pure aluminum powder (Sample 1) as metal and table salt (NaCl of Samples C and S) as hole forming medium. The aluminum powder and table salt were mixed together at ratio of 30-70 volume %. The mixture MP thus obtained was compressed at pressure of 150 MPa by using a mold, and a compressed powder member F with diameter 41 mm and height 42 mm was obtained. This compressed powder member F was placed inside an extruder to carry out a hot extrusion process under the conditions of extrusion ratio =6.9 and extrusion temperature =450° C. The molding G obtained by the extrusion molding process was immersed in water to dissolve away the table salt over a period of 18 hours.

From these examples, the following may be learned.

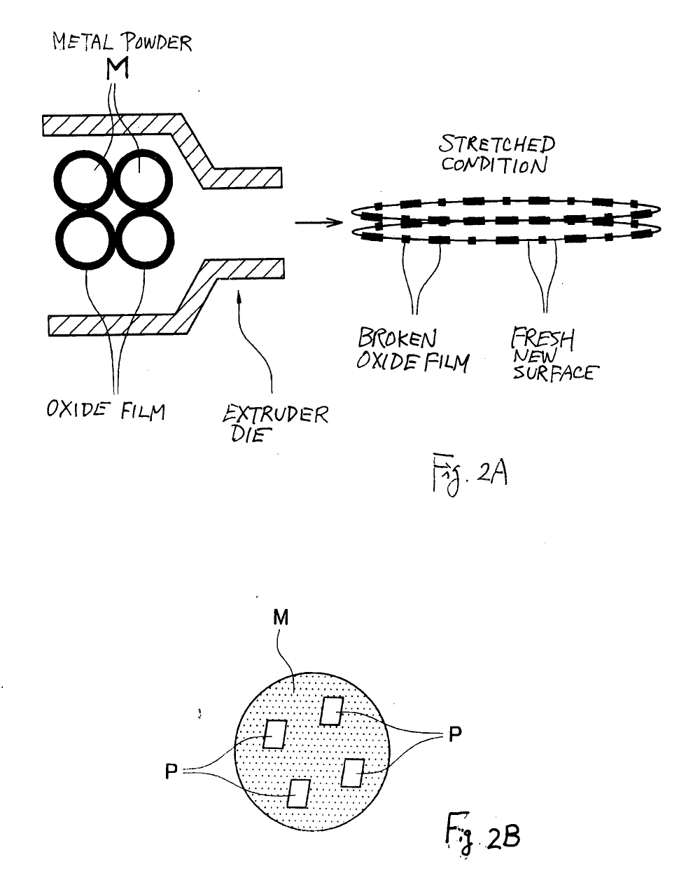

As shown in FIG. 3, the mixing ratio of table salt and porosity are in a proportional relationship, porosity becoming higher as the mixing ratio of table salt is increased. Throughout herein, porosity means the ratio of the volume of the air holes with respect to the apparent volume of the porous member. The mixing ratio of table salt is inversely proportional to the time of salt removal, the salt removal time being shorter as the mixing ratio of table salt is increased.

FIG. 4 is a graph that shows the relationship between the ratio of added table salt and the porosity after the salt removal process (for a case with extrusion ratio=6.9, extrusion temperature=450° C. and salt removal time=18 hours), white circles being related to Sample C and black circles being related to Sample S. As shown, the ratio of added table salt and the porosity are in a nearly linear relationship. Since the salt particles completely surrounded by aluminum are not removed, porosity becomes slightly less than the added amount of the table salt but porosity has reasonably good reproducibility and controllability without regard to the kind of table salt.

As shown in FIG. 5 which is a graph of a change in the salt removal ratio with respect to the added quantity of table salt (for a case with extrusion ratio=6.9, extrusion temperature=450° C. and salt removal time=18 hours), the ratio of table salt remaining without being removed increases as the volume ratio of aluminum is increased. The salt removal ratio is higher for Sample C with a wider diameter distribution.

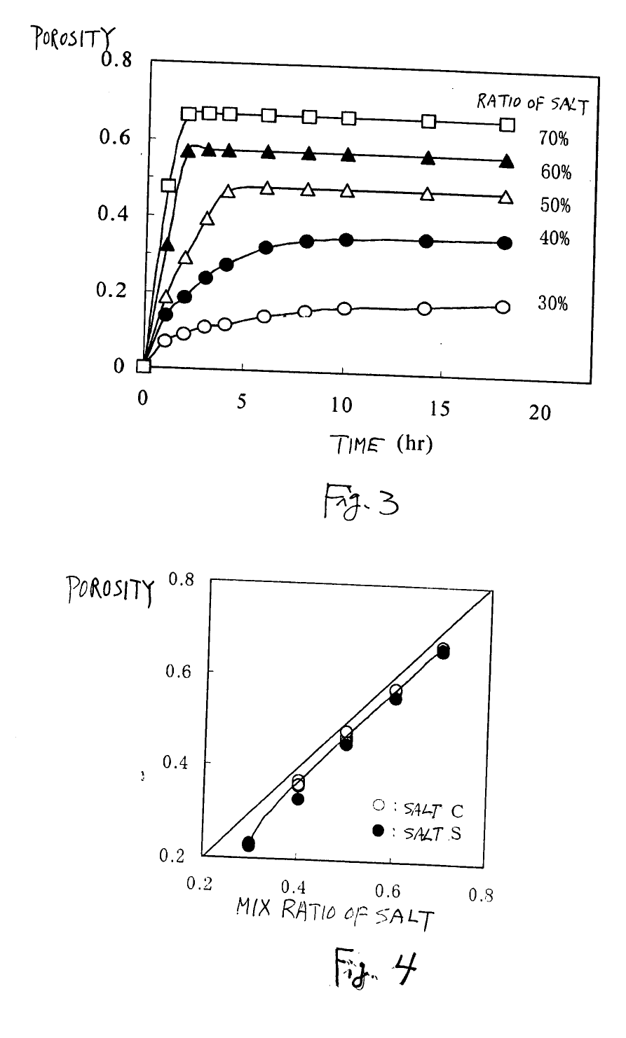

FIGS. 6A and 6B are stereo micrographs showing the fiber structure of aluminum (or its sectional view) extruded at 450° C. with mixing ratio of salt Sample C (FIG. 6A) and Sample S (FIG. 6B) =60%. It is seen therein that aluminum and table salt particles are both stretched by the extrusion, showing fiber structure.

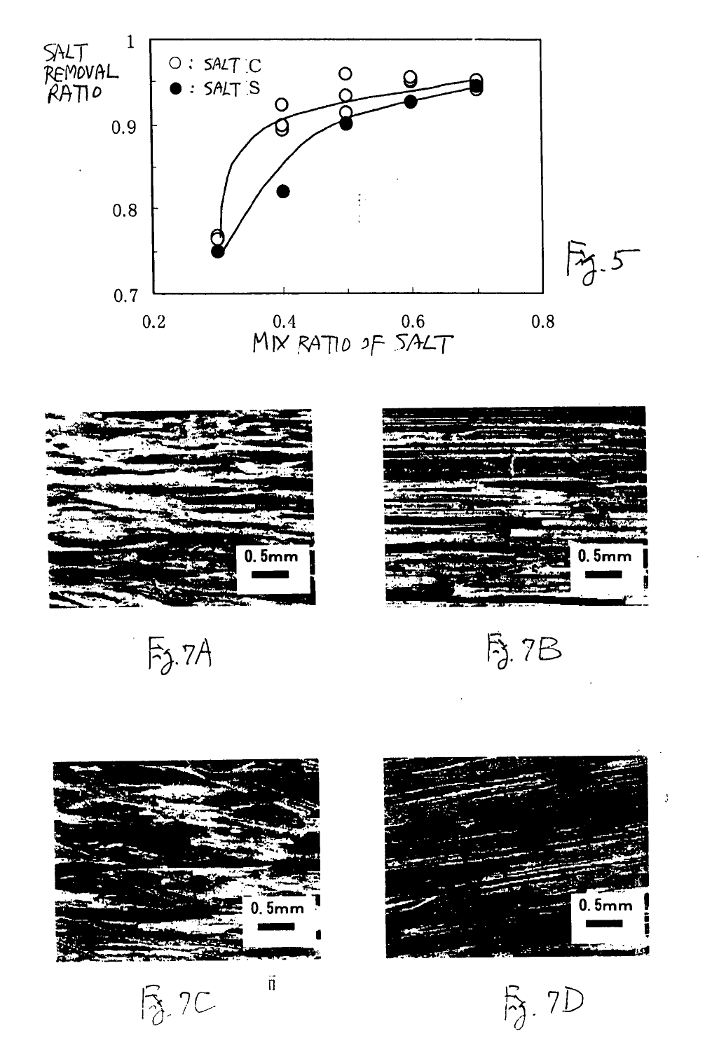

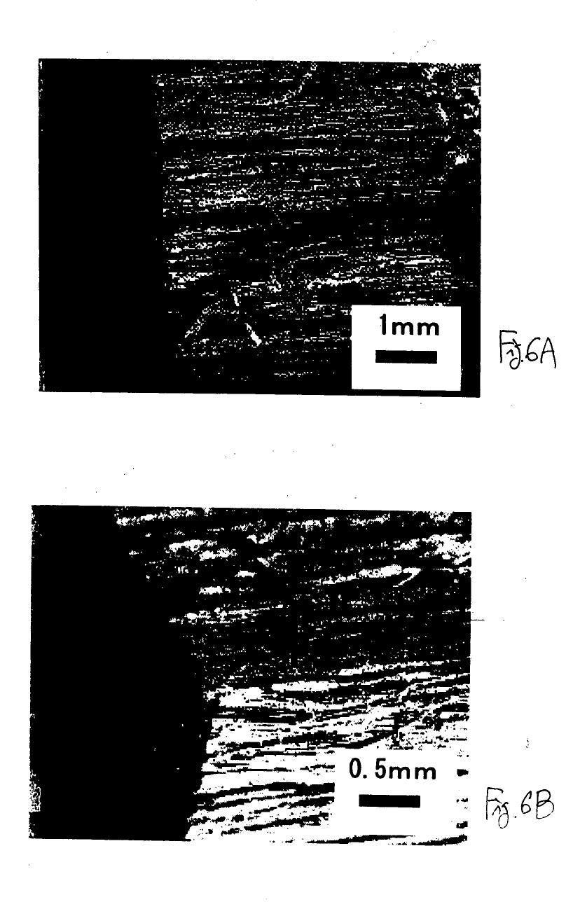

FIGS. 7A, 7B, 7C and 7D are stereo micrographs (or views of a sectional surface (FIGS. 7A and 7B) and a polished surface (FIGS. 7C and 7D) of a material containing table salt of Sample C extruded with extrusion temperature=450° C.) for comparing the stretched condition of aluminum according to the extrusion ratio. It is seen that the fiber structure is more uniform when the extrusion ratio is 17.6 (FIGS. 7B and 7D) than when it is 6.9 (FIGS. 7A and 7C). This indicates that the structure becomes finer and uniformity improves as the extrusion ratio is increased.

FIGS. 8A, 8B, 8C, 8D and 8E are stereo micrographs showing the changes in air holes on a sectional surface perpendicular to the direction of extrusion (of extruded material containing table salt of Sample C at different mixing ratios, extruded at extrusion temperature=450° C. with extrusion ratio of 6.9) according to the mixing ratio of table salt. It is seen that the distribution of the air holes is uniform in all cases in which the mixing ratio of table salt is 30 volume % (FIG. 8A), 40 volume % (FIG. 8B), 50 volume % (FIG. 8C), 60 volume % (FIG. 8D) and 70 volume % (FIG. 8E).

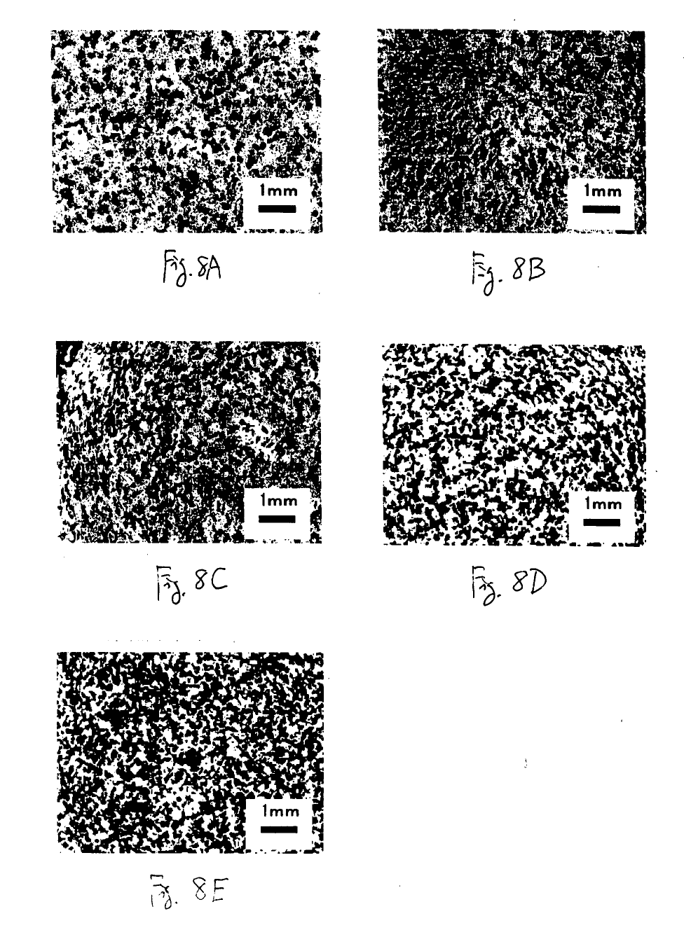

FIGS. 9A, 9B, 9C and 9D, together referred to as FIG. 9, are stereo micrographs showing the changes in the shapes and structures of air holes in an extruded material (extruded at extrusion temperature=450° C. with extrusion ratio of 6.9) according to the kind of table salt. In the case of table salt of Sample C (FIG. 9A at 40 volume % and FIG. 9C at 60 volume %) with a wide distribution in particle diameter, it is seen that a plurality of salt particles tend to join together as the mixing ratio increases, resulting in irregularly shaped air holes. In the case of table salt of Sample S (FIG. 9B at 40 volume % and FIG. 9D at 60 volume %) with purity relatively high and particle diameters relatively large and uniform, by contrast, it is seen that the air holes become quadrangular even when the mixing ratio is 60 volume % (FIGS. 9C and 9D) and that few salt particles join together.

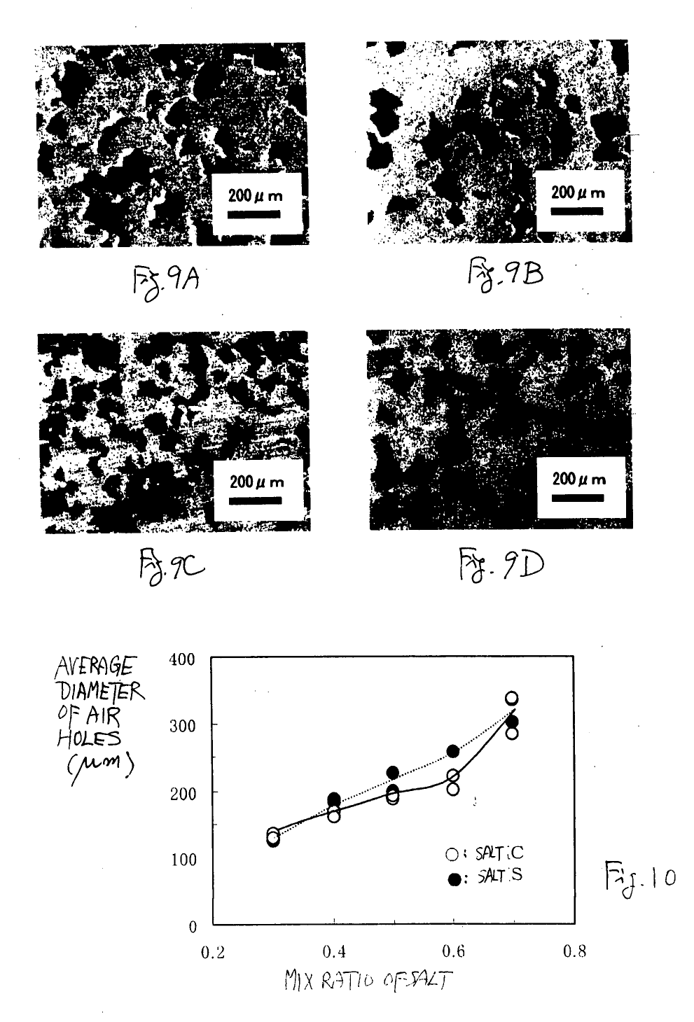

FIG. 10 is a graph that shows the changes in the average diameter of air holes (or their equivalent circles) according to the kinds and mixing ratios of table salt. FIG. 10 shows that the average diameter of air holes is about 160 μm and 180 μm, respectively corresponding to table salt of Samples C and S, as obtained from the extrusion ratio and the average particle diameter of the table salt. Thus, it is understood that the salt particles tend to join together more easily as the mixing ratio of the salt increases. As a result, air holes become irregularly shaped in a cross-sectional surface perpendicular to the direction of the extrusion but connected together to become long if the mixing ratio is high, as shown in FIG. 9.

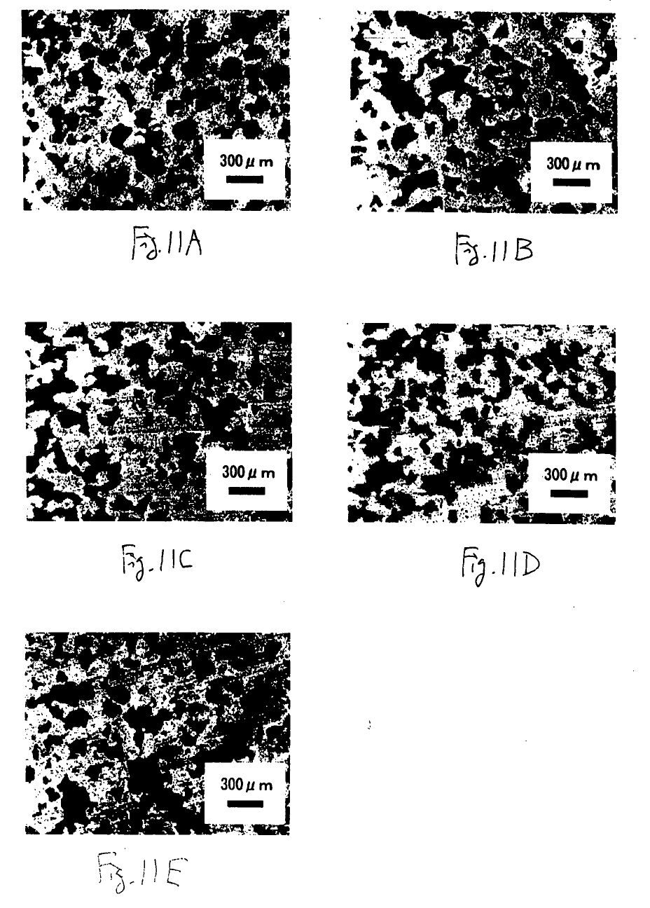

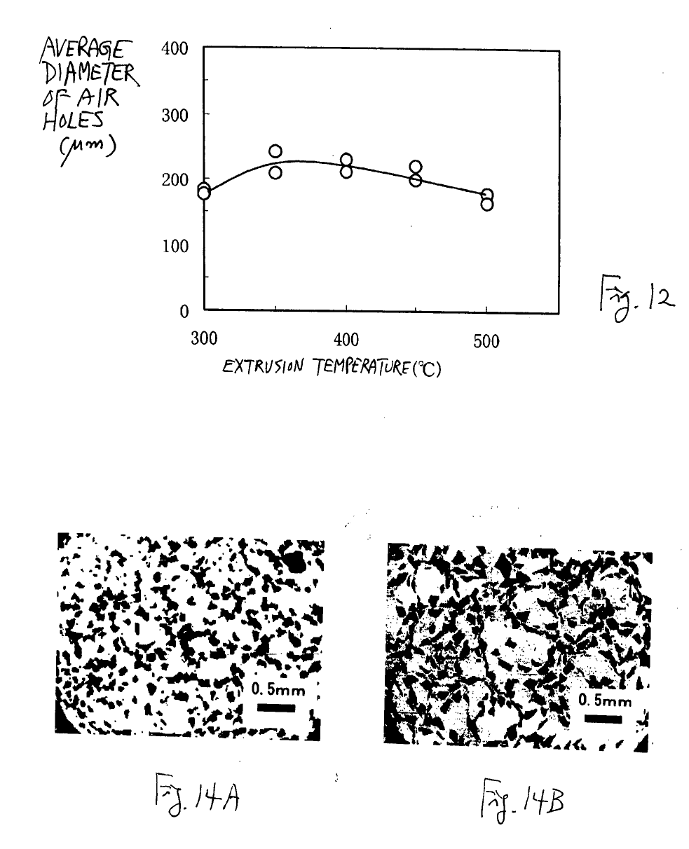

FIGS. 11A, 11B, 11C, 11D and 11E are stereo micrographs showing the changes in the shapes and structures of air holes in extruded materials (containing table salt of Sample C at 60 volume % and extruded with extrusion ratio of 6.9 and extrusion temperatures 300° C. (FIG. 11A), 350° C. (FIG. 11B), 400° C. (FIG. 11C), 450° C. (FIG. 11D) and 500° C. (FIG. 11E)) according to the extrusion temperature. Within the range of temperature 300-500° C. wherein tests were carried out, it can be seen in all cases that both aluminum and table salt particles were extended into fiber shapes and that a structure with air holes connected in one direction can be obtained by a salt removal process.

FIG. 12 is a graph that shows the changes in the average diameter of air holes according to the extrusion temperature. It is seen that the diameters of the air holes vary gently according to the extrusion temperature but the changes are small compared to the accuracy of measurements.

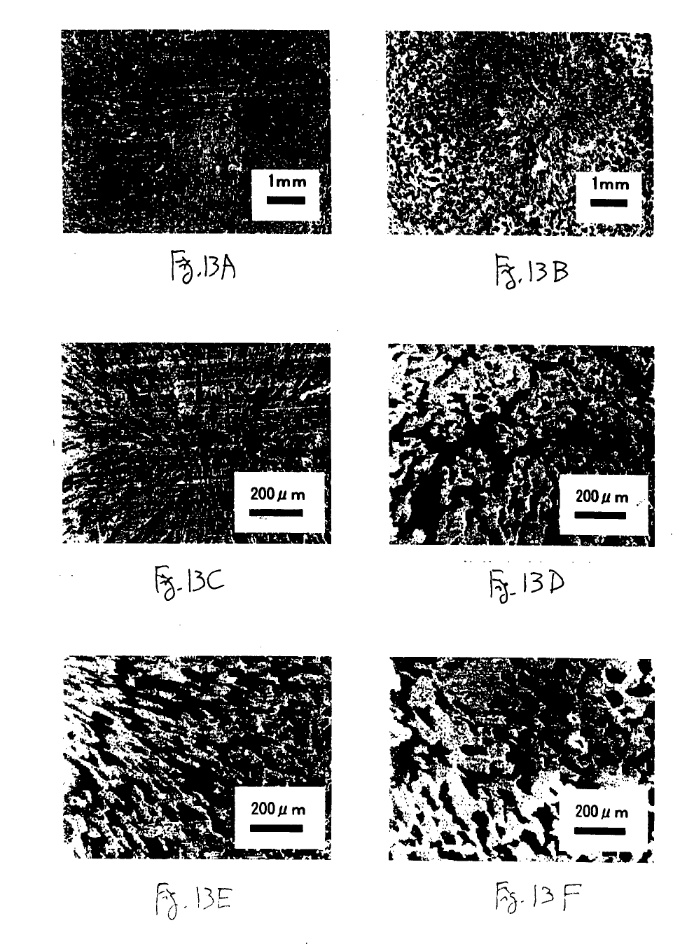

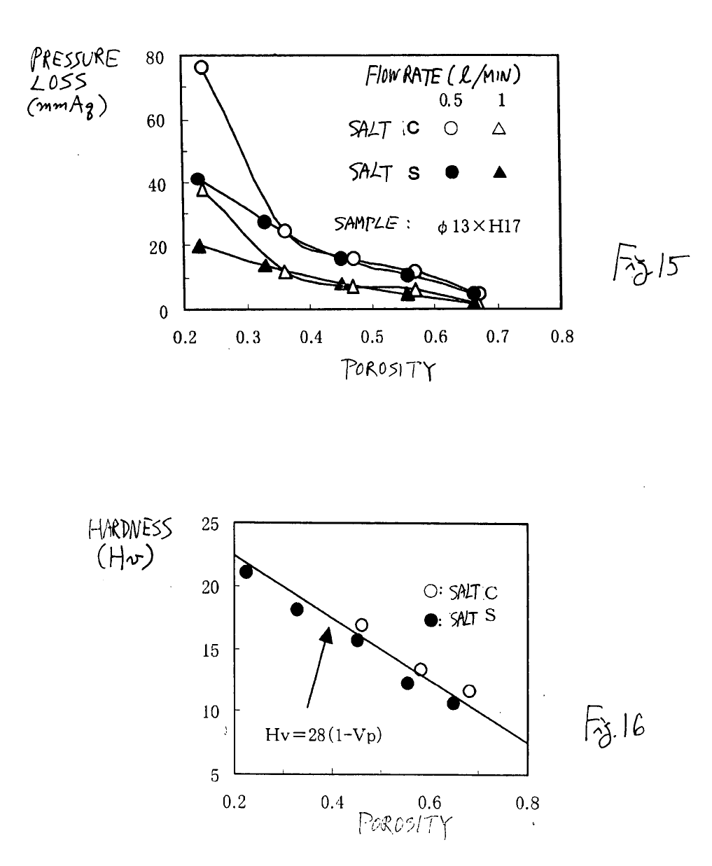

FIGS. 13A, 13B, 13C, 13D, 13E and 13F, together referred to as FIG. 13, are stereo micrographs of radial air hole structures in an extruded members containing table salt of Sample C (FIGS. 13A, 13C and 13E) or Sample S (FIGS. 13B, 13D and 13F) at 60 volume % obtained by high extrusion ratios with extrusion ratio =17.6 and extrusion temperature =450° C. FIGS. 13A and 13B are micrographs at a low magnification. FIGS. 13C and 13D are images of central portions, and FIGS. 13E and 13F are images of peripheral portions. It is seen that various air hole structures can be obtained according to the conditions of the extrusion. Since the radial structures depend also on the condition of friction with the die at the time of extrusion, it is not only the effect of increased extrusion ratio.

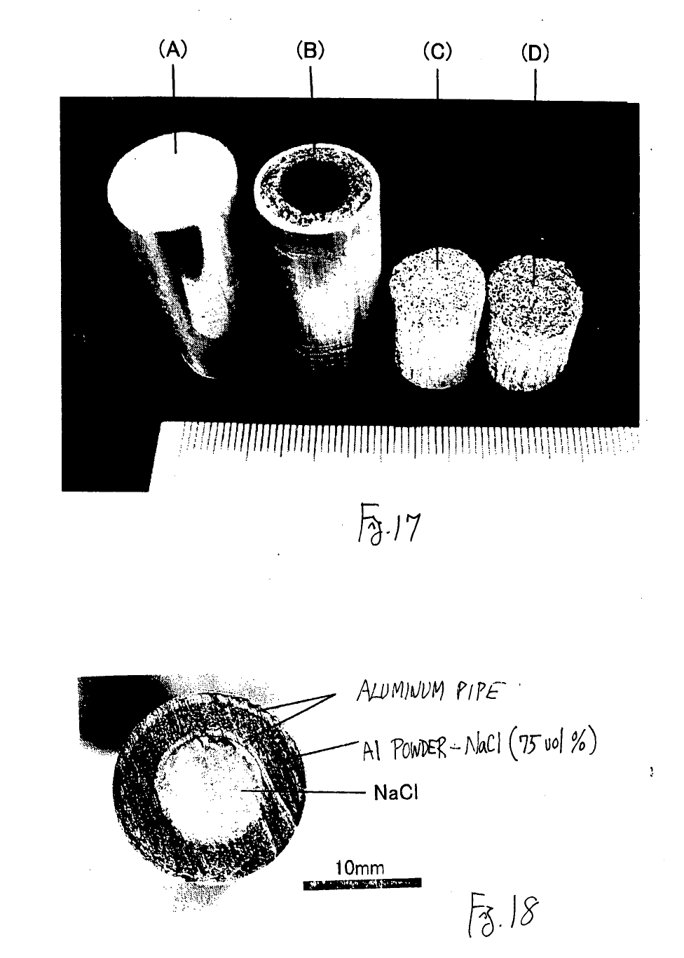

FIGS. 14A and 14B, together referred to as FIG. 14, are stereo micrographs that show the changes in the air hole structures in extruded members containing table salt of Sample S at 50 volume % and extruded with extrusion ratio=6.9 and extrusion temperature=450° C. according to the diameters of aluminum particles. FIG. 14A shows the air hole structure in aluminum of Sample 1 and FIG. 14B shows the air hole structure in aluminum of Sample 2. They show that various air hole structures can be obtained according to the diameters of aluminum and table salt particles and the diameter distributions.

FIG. 15 is a graph that shows the results of measurement of ventilation resistance of porous metals containing aluminum particles of Sample 1 and obtained by extrusion with extrusion temperature=450° C. and extrusion ratio=6.9. This graph shows that ventilation characteristics are very high if the porosity is 0.35 or higher.

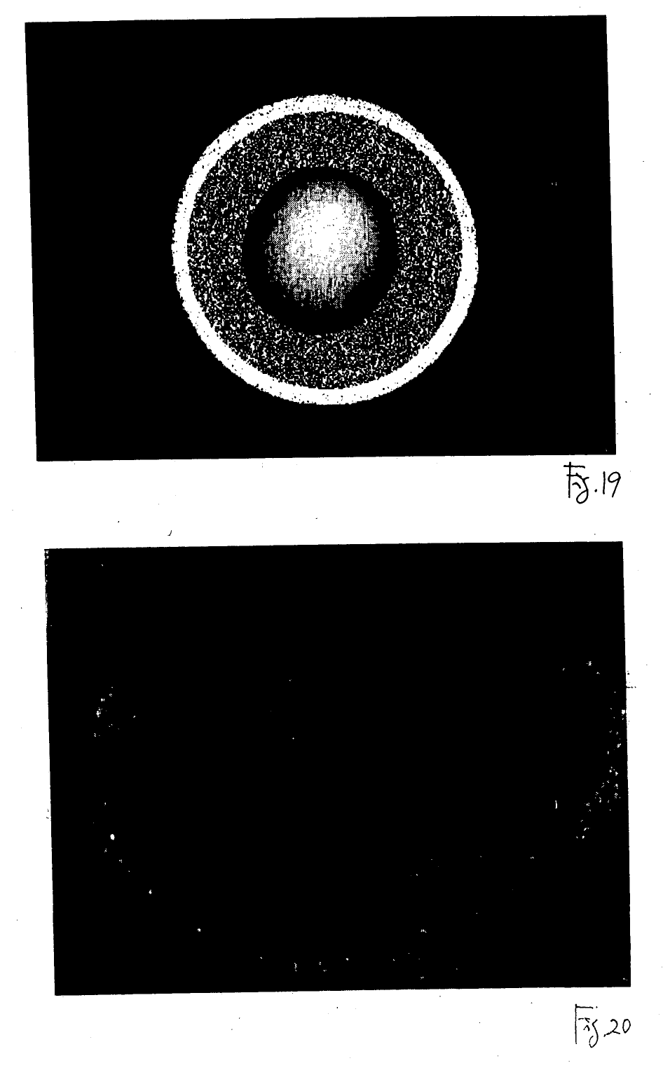

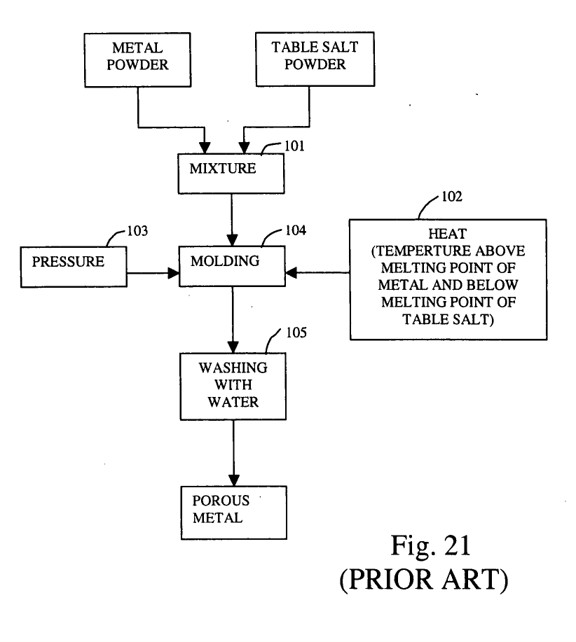

FIG. 16 is a graph that shows the results of measurement of hardness of porous metals containing aluminum particles of Sample 1 and obtained by extrusion with extrusion temperature=450° C. and extrusion ratio=6.9. This graph shows that the hardness at a sectional surface perpendicular to the direction of extrusion varies approximately according to the composite rule.

### Examples Using Other Table Salt Samples

In these examples, aluminum powder was used as metal powder but table salt with the same composition as Sample S but having a smaller (about ⅓) average diameter of 159 micron was used as Sample SS as hole forming medium.

Measured values of porosity of two samples with each of different mixing ratios were 28.4% and 28.4% at mixing ratio=30 volume %, 38.1% and 38.4% at mixing ratio=40 volume %, 48.6% and 48.9% at 50 volume %, 58.6% and 58.0% at 60 volume % and 69.7% and 69.4% at 70 volume %, indicating that reproducibility was good.

### Examples Using Salt Other Than Table Salt

In these examples, aluminum powder of Sample 1 was used as metal powder but potassium chloride KCL was used as hole forming medium. Extrusion processes were carried out at extrusion temperature=450° C. with extrusion ratio=6.9 and with mixing ratios for KCl =30 volume %, 40 volume %, 50 volume %, 60 volume % and 70 volume %. There was no problem with the extrusion but it was found to break up easily at the time of the salt removal process. It may be because KCl is softer than table salt and hence more easily enters between the aluminum particles to cover the aluminum surfaces, preventing the aluminum particles from bonding.

Measured porosity values (two samples at each mixing ratio) were 27.5% and 28.6% at 30 volume %, 37.4% and 37.9% at 40 volume %, 48.5% and 48.6% at 50 volume %, 59.2% and 59.1% at 60 volume % and 69.6% and 69.2% at 70 volume %. It is seen that reproducibility was good. It was easy to break up at 60 volume % and 70 volume % at the time of the salt removal.

### FIELD OF INDUSTRIAL APPLICATION

Since the porous metals of this invention having air holes extending in one direction have superior characteristics regarding continuity and ventilation and a small pressure loss, they are suitable as a filtering material. Since their porosity is high, they are much lighter than they appear to be. Thus, lighter and stronger components can be provided according to this invention, serving, for example, as a shock absorber, a heat insulator, an acoustic insulator, a sound absorber and a vibration proofing material.

The production technology of this invention is very simple and easy. Since table salt may be the only discharged material, this technology has the merit of being gentle to the environment.

What is claimed is:

1. A process of producing a porous metal, said process comprising sequentially carrying out the steps of:
obtaining a mixture by mixing metal powder and hole forming medium powder;
obtaining a molding by stretching said mixture; and
dissolving and thereby removing said hole forming medium powder from said molding.

2. The process of claim 1 wherein said molding is obtained by an extrusion process.

3. The process of claim 1 wherein said molding is obtained by a rolling process.

4. The process of claim 1 wherein said molding is obtained by heating to a temperature lower than the melting points of said metal powder and said hole forming medium powder.

5. The process of claim 1 further comprising the step of obtaining a compressed powder member by compressing said mixture prior to the step of stretching said mixture.

6. A porous metal that is an extruded product obtained by the process of claim 1, said extruded product having continuous air holes that are mutually independent within a sectional surface of said extruded product and extends in the direction of extrusion.

7. The porous metal of claim 6 wherein said molding is obtained by an extrusion process.

8. The porous metal of claim 6 wherein said molding is obtained by heating to a temperature lower than the melting points of said metal powder and said hole forming medium powder.

9. The porous metal of claim 6 wherein said process of claim 1 further comprises the step of obtaining a compressed powder member by compressing said mixture prior to the step of stretching said mixture.

10. A porous metal that is a rolled product obtained by the process of claim 1, said rolled product having continuous air holes formed within said rolled product and extending in the direction of rolling.

11. The porous metal of claim 10 wherein said molding is obtained by a rolling process.

12. The porous metal of claim 10 wherein said molding is obtained by heating to a temperature lower than the melting points of said metal powder and said hole forming medium powder.

13. The porous metal of claim 10 wherein said process of claim 1 further comprises the step of obtaining a compressed powder member by compressing said mixture prior to the step of stretching said mixture.

14. A porous metal comprising a metallic member formed by stretching in one direction and having continuous air holes within a sectional area.

15. A porous metallic structure comprising:
a porous metal formed by stretching in one direction and having continuous air holes formed in the direction of stretching in a sectional area; and
a non-porous metallic member laminated to said porous metal.
